(19) United States
(12) Patent Application Publication
(10) Pub. No.: US 2026/0222935 A1
(43) Pub. Date: Jul. 30, 2026

(54) ACTIVATION AND/OR DEACTIVATION OF MULTIPLE PRE-CONFIGURED MEASUREMENT GAPS

(71) Applicant: APPLE INC., Cupertino, CA (US)

(72) Inventors: Qiming Li, Beijing (CN); Yuexia Song, Beijing (CN); Jie Cui, San Jose, CA (US); Yang Tang, San Jose, CA (US); Dawei Zhang, Saratoga, CA (US)

(21) Appl. No.: 19/148,493

(22) PCT Filed: Feb. 17, 2023
(86) PCT No.: PCT/CN2023/076844

§ 371 Date: Jul. 16, 2025

(51) Int. Cl. H04W 36/00; H04B 17/318

(52) U.S. Cl. CPC H04W 36/0085; H04B 17/318; H04W 36/00692

(57) ABSTRACT

The present disclosure is related to techniques for activation and/or deactivation of multiple pre-configured measurement gaps (Pre-MGs) in a wireless communication system. In some embodiments, a user equipment device (UE) is configured to detect one or more trigger events for a plurality of BWPs serving the UE; and in response to at least one of the one or more trigger events being detected, determine to perform a pre-configured measurement gap (MG) status change for the plurality of BWPs, wherein performing the pre-configured MG status change comprises activating or deactivating one or more pre-configured MGs for the plurality of BWPs.

### TECHNICAL FIELD

This application relates generally to wireless communication systems, including wireless communication systems where multiple pre-configured measurement gaps (or pre-configured MGs, or Pre-MGs for short) can be effectively used.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

In accordance with a first aspect, a user equipment device (UE) including one or more antennas, a transceiver, and a processor as well as a method performed by a UE are disclosed. In some embodiments, the processor is configured to cause the UE to perform the method, comprising: detecting one or more trigger events for a plurality of BWPs serving the UE; and in response to at least one of the one or more trigger events being detected, determining to perform a pre-configured measurement gap (MG) status change for the plurality of BWPs, wherein performing the pre-configured MG status change comprises activating or deactivating one or more pre-configured MGs for the plurality of BWPs.

In accordance with a second aspect, a network device including one or more antennas, a transceiver, and a processor as well as a method performed by a network device are disclosed. In some embodiments, the processor is configured to cause the network device to perform the method, comprising: detecting one or more trigger events for a plurality of BWPs serving a user equipment device (UE); determining that a pre-configured measurement gap (MG) status change is to be performed for the plurality of BWPs by the UE in response to at least one of the one or more trigger events, wherein performing the pre-configured MG status change comprises activating or deactivating one or more pre-configured MGs on the plurality of BWPs; and tracking when the one or more pre-configured MGs are active for each of the plurality of BWPs, based at least on one or more capabilities of the UE.

In accordance with a third aspect, an apparatus for operating a user equipment device (UE) is disclosed. In some embodiments, the apparatus includes a processor configured to cause the UE to perform methods disclosed herein.

In accordance with a fourth aspect, an apparatus for operating a network device is disclosed. In some embodiments, the apparatus includes a processor configured to cause the network device to perform methods disclosed herein.

In accordance with a fifth aspect, a non-transitory computer-readable memory medium storing program instructions is disclosed. In some embodiments, when executed by a computer system, the instructions cause implementation of method disclosed herein.

In accordance with a sixth aspect, a computer program product comprising program instructions is disclosed. In some embodiments, when executed by a computer system, the instructions cause implementation of method disclosed herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates example pre-configured MGPs for a UE, according to embodiments disclosed herein.

FIG. 4 illustrates examples of how multiple pre-configured MGs can be used with BWPs on which a UE is served, according to embodiments disclosed herein.

FIG. 5 illustrates an example flowchart for activation and/or deactivation of multiple pre-configured MGs, according to embodiments disclosed herein.

FIGS. 6A-7C illustrate a plurality of example durations of multiple pre-configured MGs status changes, according to embodiments disclosed herein.

FIGS. 8-9 illustrates example methods for communication according to embodiments disclosed herein.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
BWP: Bandwidth Part
CA: Carrier Aggregation
CSI-RS: Channel State Information-Reference Signal
DCI: Downlink Control Information
FR: Frequency Range
MAC CE: Medium Access Control Control Element
MG: Measurement Gap
MGP: Measurement Gap Pattern
MGRP: Measurement Gap Repetition Period
NR: New Radio
NW: Network
Pre-MG: Pre-configured Measurement Gap
Pre-MGP: Pre-configured Measurement Gap Pattern
PRS: Positioning Reference Signal
RAN: Radio Access Network
RRC: Radio Resource Control
RRM: Radio Resource Management
RS: Reference Signal
SSB: Synchronization Signal Block
UE: User Equipment

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

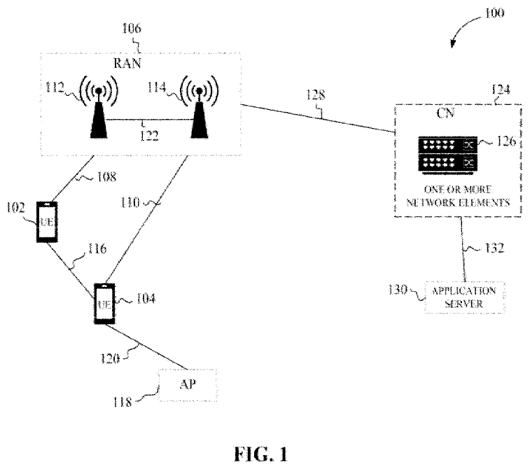

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

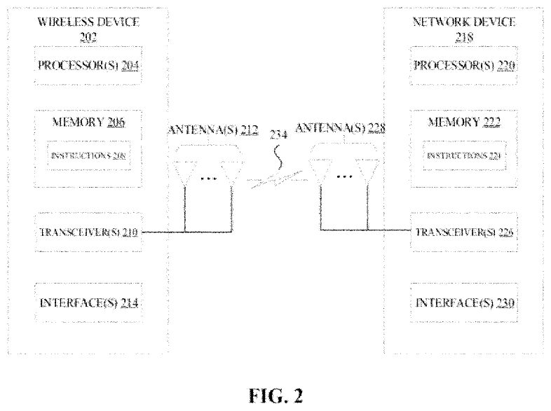

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

Overview of Multiple Pre-MGs Activation and/or Deactivation

In 3GPP NR, a pre-configured measurement gap pattern (MGP) (or Pre-MGP for short) is introduced. The pre-configured MGP can be configured in advance by a network device, so that signaling overheads and processing on the UE and the network sides involved in the configuration process will not cause delay in real time use of the MGP by the UE. The pre-configured MGP can define multiple pre-configured measurement gaps (MGs) (or Pre-MGs for short) for the UE, which can be used by the UE to perform various types of measurements on cells of serving carriers and non-serving carriers (e.g., inter-frequency carrier, inter-Radio Access Technology (RAT) carriers, etc.).

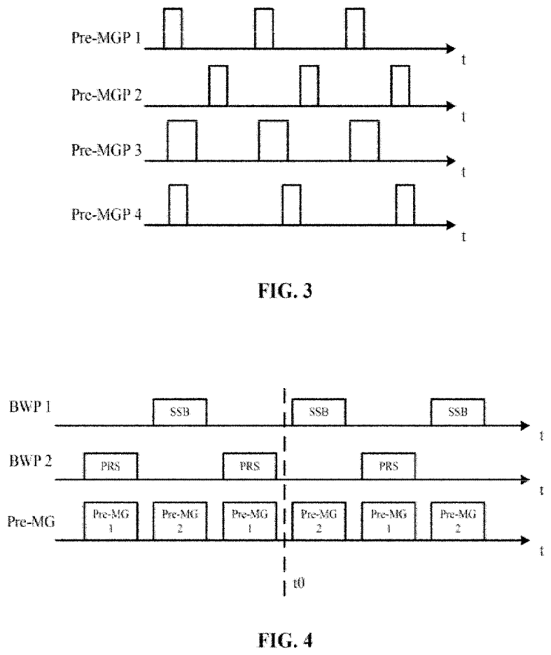

FIG. 3 illustrates example pre-configured MGPs for a UE, according to embodiments disclosed herein. A pre-configured MGP can be characterized by several parameters, including: measurement gap length (MGL), measurement gap repetition period (MGRP), and MG time offset with respect to a reference time. In the example of FIG. 3, Pre-MGP 1 and Pre-MGP 2 are characterized by different MG time offsets, Pre-MGP 1 and Pre-MGP 3 are characterized by different MGLs, and Pre-MGP 1 and Pre-MGP 4 are characterized by different MGRPs.

In 3GPP NR, to enable the UE power saving and avoid interference, the UE can be configured with a set of BWPs for signal receptions by the UE in a serving cell (e.g., Primary Cell (PCell), Primary Secondary Cell (PSCell)), Serving Cell (SCell), and with a set of BWPs for signal transmissions by the UE in a serving cell. The set of BWPs for signal receptions by the UE is referred to as a downlink (DL) BWP set and may include, e.g., up to four DL BWPs. The set of BWPs for signal transmissions by the UE is referred to as an uplink (UL) BWP set and may include, e.g., up to four UL BWPs.

Each BWP can be associated with multiple parameters. Examples of such parameters include bandwidth (BW) (e.g., number of time-frequency resources), location of the BWP in frequency (e.g., starting resource block (RB) index of the BWP or center frequency of the BWP, etc.), subcarrier spacing (SCS), cyclic prefix (CP) length, any other baseband parameter. At a time, at least one of the set of BWPs is active. For example, only one BWP is active at a time during an RRC_Connected state.

In some embodiments, a UE can be configured with multiple pre-configured MGPs, thus multiple pre-configured MGs can be defined by respective pre-configured MGPs. The multiple pre-configured MGs may be in an active status for measurements of reference signals outside of an active BWP, or in an inactive status when such measurements are not necessary. Accordingly, mechanisms are necessary for controlling status changes (including activation and/or deactivation, for example) of multiple pre-configured MGs.

There are multiple trigger events which may trigger multiple pre-configured MGs status changes. The multiple pre-configured MGs status changes may include status changes of multiple pre-configured MGs, for example, activation and/or deactivation of a respective one of the multiple pre-configured MGs. In some embodiments, such trigger events include at least one of an active BWP switching based on a DCI, a timer or an RRC signaling; a SCell activation and/or deactivation; an addition, release and/or change of a SCell in carrier aggregation; or an addition and/or removal of one or more measurement objects.

In an example of active BWP switching, when a BWP becomes active after a first BWP status change, one or more pre-configured MGs may be activated for measurements on cells of the serving carrier in some scenarios, if the measured signals (e.g., SSB, CSI-RS, PRS, etc.) are not fully within the active BWP of the serving cell. In some embodiments, when the active BWP becomes inactive after a second BWP status change, the one or more active pre-configured MGs may be deactivated from measurements discussed above. In examples of the other trigger events, one or more pre-configured MGs can be activated or deactivated in a similar manner, depending on if the measured signals are fully within an active BWP or not. In the following description, although the active BWP switching is more referred to as an example trigger event, the descriptions are intended to be equally applied to other trigger events.

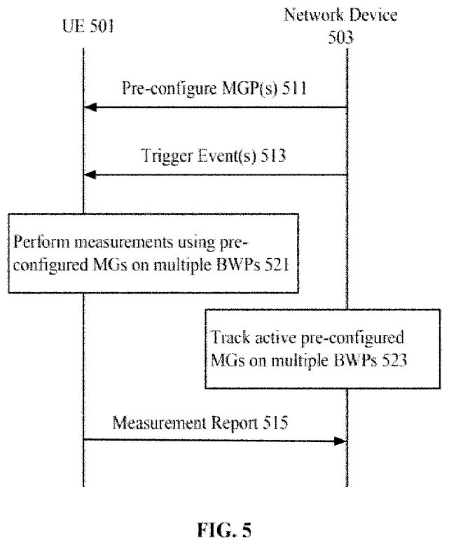

FIG. 4 illustrates examples of how multiple pre-configured MGs can be used with BWPs on which a UE is served, according to embodiments disclosed herein. Although two BWPs, pre-configured MGs defined by two pre-configured MGPs, and two reference signals are discussed with reference to FIG. 4, the number or types of the BWPs, pre-configured MGPs, or the reference signals are not intended to be limited thereto.

In the example of FIG. 4, it is supposed that the two reference signals, i.e., SSBs and PRSs, are arranged within respective frequency range of BWP 1 and BWP 2. Pre-configured MG 1 may be defined by a pre-configured MGP 1, and pre-configured MG 2 may be defined by a pre-configured MGP 2. Each pre-configured MG 1 contains the PRS in the time dimension, and each pre-configured MG 2 contains the SSB in the time dimension. Table 1 below lists six scenarios and shows how statuses of pre-configured MGs can be related to the active BWP(s).

In scenario I, the active BWP is BWP 1 all the time. Since a measured signal (i.e., PRS) is not fully within (i.e., outside of) the active BWP 1, the pre-configured MG 1 is kept active all the time to measure the PRS. In this scenario, there are trigger events for the BWPs, no pre-configured MG status changes are necessary accordingly.

Scenario II is similar to scenario I. In scenario II, the active BWP is BWP 2 all the time. Since a measured signal (i.e., SSB) is not fully within (i.e., outside of) the active BWP 2, the pre-configured MG 2 is kept active all the time to measure the SSB. In this scenario, there are no trigger events for the BWPs, no pre-configured MG status changes are necessary accordingly. In scenario III, the active BWP is BWP 1 before the time instant to, and is changed to BWP 2 after t0. For example, the BWP status change may be triggered by some events (e.g., an active BWP switch), as will be described hereinafter. Before to, since a measured signal (i.e., PRS) is not fully within (i.e., outside of) the active BWP 1, the pre-configured MG 1 is kept active to measure the PRS. After t0, since a measured signal (i.e., SSB) is not fully within (i.e., outside of) the active BWP 2, the pre-configured MG 2 is kept active to measure the SSB. In this scenario, the BWP status changes include an active-to-inactive change for BWP 1 and an inactive-to-active change for BWP 2, which may be triggered by an active BWP switch in an example. Accordingly, the pre-configured MG status changes include deactivation of the pre-configured MG 1 and activation of the pre-configured MG 2.

Scenario IV is similar to scenario III. In scenario IV, the active BWP is BWP 2 before the time instant t0, and is changed to BWP 1 after t0. The BWP status change may be triggered by some events (e.g., an active BWP switch). Before to, since a measured signal (i.e., SSB) is not fully within (i.e., outside of) the active BWP 2, the pre-configured MG 2 is kept active to measure the SSB. After t0, since a measured signal (i.e., PRS) is not fully within (i.e., outside of) the active BWP 1, the pre-configured MG 1 is kept active to measure the PRS. In this scenario, the BWP status changes include an inactive-to-active change for BWP 1 and an active-to-inactive change for BWP 2. Accordingly, the pre-configured MG status changes include activation of the pre-configured MG 1 and deactivation of the pre-configured MG 2.

In scenario V, BWP 1 and BWP 2 are both active before the time instant t0, and are both inactive after t0. For example, the BWP status change may be triggered by some events, as will be described hereinafter. Before t0, since a measured signal (i.e., PRS) is not fully within (i.e., outside of) the active BWP 1, the pre-configured MG 1 is kept active to measure the PRS. Since a measured signal (i.e., SSB) is not fully within (i.e., outside of) the active BWP 2, the pre-configured MG 2 is kept active to measure the SSB. After t0, the pre-configured MGs 1 and 2 are kept inactive at least for BWPs 1 and 2. In this scenario, the BWP status changes include an active-to-inactive change for both BWP 1 and BWP 2. Accordingly, the pre-configured MG status changes include deactivation of both the pre-configured MGs 1 and 2.

Scenario VI is similar to scenario V. In scenario VI, BWP 1 and BWP 2 are both inactive before the time instant t0, and are both active after t0. The BWP status change may be triggered by some events. Before to, the pre-configured MGs 1 and 2 are kept inactive at least for BWPs 1 and 2. After t0, since a measured signal (i.e., PRS) is not fully within (i.e., outside of) the active BWP 1, the pre-configured MG 1 is kept active to measure the PRS. Since a measured signal (i.e., SSB) is not fully within (i.e., outside of) the active BWP 2, the pre-configured MG 2 is kept active to measure the SSB. In this scenario, the BWP status changes include an inactive-to-active change for both BWP 1 and BWP 2. Accordingly, the pre-configured MG status changes include activation of both the pre-configured MGs 1 and 2.

TABLE 1

| Scenario | Active BWP | Pre-MG Status | Pre-MG Status Change |
|---|---|---|---|
| I | BWP 1 | Pre-MG 1 active | no |
| II | BWP 2 | Pre-MG 2 active | no |
| III | BWP 1, before t0; | Pre-MG 1 active, before t0; | deactivate Pre-MG 1; |
| | BWP 2, after t0 | Pre-MG 2 active, after t0 | activate Pre-MG 2 |
| IV | BWP 2, before t0; | Pre-MG 2 active, before t0; | deactivate Pre-MG 2; |
| | BWP 1, after t0 | Pre-MG 1 active, after t0 | activate Pre-MG 1 |
| V | BWP 1&2, before t0 | Pre-MG 1&2 active, before t0 | deactivate Pre-MG 1&2 |
| VI | BWP 1&2, after t0 | Pre-MG 1&2 active, after t0 | activate Pre-MG 1&2 |

Trigger events for the BWP status change include at least one of: an active BWP switching based on a DCI, a timer or an RRC signaling; a SCell activation and/or deactivation; an addition, release and/or change of a SCell in carrier aggregation; or an addition and/or removal of one or more measurement objects.

The active BWP switching may be a typical trigger event for the BWP status change. In some embodiments, the UE is served in a serving cell only on one active BWP. The UE can be configured to switch the active BWP based on a timer (e.g., BWP inactivity timer such as bwp-InactivityTimer), by receiving a command or a message from another node (e.g., from the network device), etc. Examples of such a command or message are DL control information (DCI) sent on PDCCH, Radio Resource Control (RRC) message, Medium Access Control (MAC) command, etc. The active BWP switching operation may involve change in one or more parameters associated with the BWP described above. The active BWP switching may involve delay, e.g., a few of slots. This active BWP switching delay depends on one or multiple factors, e.g., type of BWP switching, number of serving cells on which the BWP switching is triggered simultaneously or non-simultaneously (e.g., over partially overlapping time periods), etc.

As can be seen from FIG. 4, in some embodiments, the multiple pre-configured MG status changes may be in response to an active BWP switching. In particular, activation or deactivation of BWPs may trigger activation or deactivation of pre-configured MGs. However, it further depends upon if some bandwidth requirement is met, to determine if the activation or deactivation of pre-configured MGs is indeed necessary. For example, the bandwidth requirement may include at least one of a first requirement that, when the trigger event is to activate the BWP, one or more reference signals used for measurements on the BWP after the BWP status change are not fully within a bandwidth of the BWP; or a second requirement that, when the trigger event is to deactivate the BWP, one or more reference signals used for measurements on the BWP before the BWP status change were not fully within the bandwidth of the BWP.

Other trigger events described above can equally trigger the multiple pre-configured MG status changes. More generally, the bandwidth requirement may include at least one of a first requirement that, one or more reference signals used for measurements on a BWP after the trigger event are not fully within a bandwidth of an active BWP; or a second requirement that, one or more reference signals used for measurements on a BWP before the trigger event were not fully within the bandwidth of an active BWP.

### Example Operations for Multiple Pre-MGs Activation and/or Deactivation

As illustrated above, status changes of multiple pre-configured MGs may involve changing the statuses of multiple pre-configured MGs. In an example, multiple pre-configured MGs include at least two pre-configured MGs, e.g., pre-configured MG 1+pre-configured MG 2. In an example, changing the statuses of multiple pre-configured MGs includes activating or deactivating the multiple pre-configured MGs.

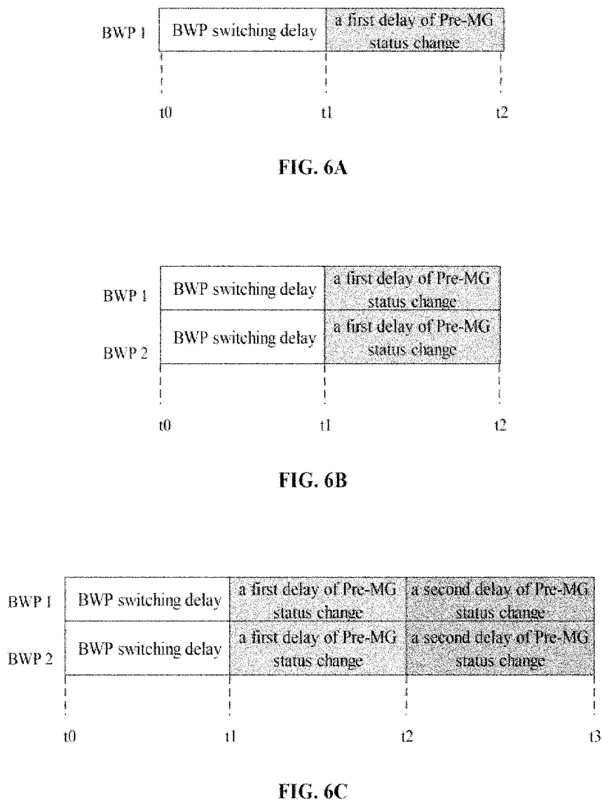

FIG. 5 illustrates an example flowchart for activation and/or deactivation of multiple pre-configured MGs, according to embodiments disclosed herein. In FIG. 5, the operations are performed by a UE 501 and a network device 503, and the UE 501 is served on a plurality of BWPs at least part of which is provided by the network device 503. In FIG. 5, the UE 501 may correspond to any of the UEs and the wireless device of FIG. 1 and FIG. 2. The network device 503 may correspond to any of the base stations or the network device of FIG. 1 and FIG. 2.

In FIG. 5, at 511, the network device 503 transmits, to the UE 501, information indicating one or more pre-configured MGPs. The UE 501 receives such information accordingly. The information may indicate parameters of one or more pre-configured MGPs, including a MGL, a MGRP, and a MG time offset with respect to a reference time, for example. Each pre-configured MGP further defines one or more pre-configured MGs for the plurality of BWPs.

At 513, the network device 503 transmits, to the UE 501, trigger event(s) related signaling. The UE 501 receives such signaling, accordingly. In an example, such signaling can be used to control operations of multiple pre-configured MGs status changes for the plurality of BWPs. The trigger event(s) related signaling may be transmitted via a DCI on the PDCCH, an RRC message, or a MAC control element (CE). In some embodiments, the trigger event(s) related signaling may indicate one or more trigger events for the plurality of BWPs. For example, the one or more trigger events include at least one of: an active BWP switching based on a DCI, a timer or an RRC signaling; a SCell activation and/or deactivation; an addition, release and/or change of a SCell in carrier aggregation; or an addition and/or removal of one or more measurement objects.

At 521, the UE 501 performs measurements using pre-configured MGs on some or all of the plurality of BWPs. For example, the UE 501 further controls the statues of the plurality of BWPs based on the trigger event(s) related signaling received from the network device 503. In some embodiments, based on such signaling, the UE 501 may detect one or more trigger events for the plurality of BWPs, and determine that the one or more trigger events are to trigger BWP status changes for the plurality of BWPs. The UE 501 may begin to perform BWP status changes for the plurality of BWPs, accordingly. In some embodiments, the UE 501 may update measurement scheduling (e.g., measurement objects) based on some trigger events.

For example, in response to performing the BWP status changes for the plurality of BWPs or updating the measurement scheduling, the UE 501 may determine to perform pre-configured MG status change(s) for the plurality of BWPs. In an example, performing the pre-configured MG status change(s) comprises activating one or more pre-configured MGs for each BWP which is to be activated after a respective BWP status change, or deactivating one or more pre-configured MGs for each BWP which is to be deactivated after a respective BWP status change.

In some embodiments, performing the pre-configured MG status change(s) for the plurality of BWPs is further in response to some bandwidth requirement being met. For example, the bandwidth requirement includes at least one of: a first requirement that, when the BWP status change is to activate one of the plurality of BWPs, one or more reference signals used for measurements on the BWP after the BWP status change are not fully within a bandwidth of the BWP; and/or a second requirement that, when the BWP status change is to deactivate one of the plurality of BWPs, one or more reference signals used for measurements on the BWP before the BWP status change were not fully within the bandwidth of the BWP. In an example, the UE 501 may determine, autonomously or based on a notification from the network device 503, if the bandwidth requirement is met for at least one of the plurality of BWPs. More generally, the bandwidth requirement may include at least one of a first requirement that, one or more reference signals used for measurements on a BWP after the trigger event are not fully within a bandwidth of an active BWP; or a second requirement that, one or more reference signals used for measurements on a BWP before the trigger event were not fully within the bandwidth of an active BWP.

For example, the UE 501 may create one or more pre-configured MGs based on the pre-configured MGPs. The UE 501 performs measurements on one or more reference signals using the active pre-configured MGs, to obtain measurement results. In NR, the Reference Signals (RS) (e.g., Synchronization Signal Block (SSB), Channel State Information Reference Signal (CSI-RS), Positioning Reference Signal (PRS), etc.) are used by the UE for performing different types of measurements for different purposes, e.g., for mobility, for Radio Link Monitoring (RLM) related procedure, for beam management (BM) related procedure, for positioning, for scheduling and link adaptation, etc.

Then, at 515, the UE 501 transmits one or more measurement reports to the network device 503.

A523, the network device 503 may track active pre-configured MGs for the plurality of BWPs. During an active pre-configured MG, the UE 501 cannot be scheduled for receiving/transmitting signals on the active BWP. Accordingly, with knowledge of active (and/or inactive) pre-configured MGs for the plurality of BWPs, the network device 503 can determine when to schedule the UE 501 on each BWP.

In order to track when the pre-configured MGs are active for the plurality of BWPs, the network device 503 may determine that one or more trigger events are to trigger BWP status changes for the plurality of BWPs. The network device 503 may further determine that a pre-configured MG status change is to be performed for each of the plurality of BWPs by the UE 501 in response to the BWP status changes.

Moreover, the network device 503 may adopt a same scheme or mechanism as the UE 501 to determine an active or inactive status of each pre-configured MG. For example, the network device 503 may determine if the above bandwidth requirement is met for each of the plurality of BWPs, and determine if the pre-configured MG status change is to be performed for each of the plurality of BWPs by the UE. In an embodiment, the network device 503 even notifies the UE 501 if the bandwidth requirement is met for at least one of the plurality of BWPs.

In some embodiments, tracking the active pre-configured MGs may be based at least on one or more capabilities of the UE. Such capabilities of the UE may be related to a capacity of or operations within a measurement module of the UE, and may impact the timing when the pre-configured MG status changes are completed and thus become effective. As will be described hereinafter, the one or more capabilities of the UE include at least one of: a first capability indicating whether the UE 501 supports dependent and/or independent MG status changes for multiple BWPs; a second capability indicating a per frequency range value of an incremental margin D for a duration of simultaneous pre-configured MG status changes for multiple BWPs; a third capability indicating an extension E2 for a duration of partially overlapped pre-configured MG status changes for multiple BWPs; or a fourth capability indicating whether the UE 501 supports simultaneous pre-configured MG status change and pre-configured MGs scheduling on different BWPs.

Timeline Analysis on Multiple Pre-Configured MGs Activation and/or Deactivation

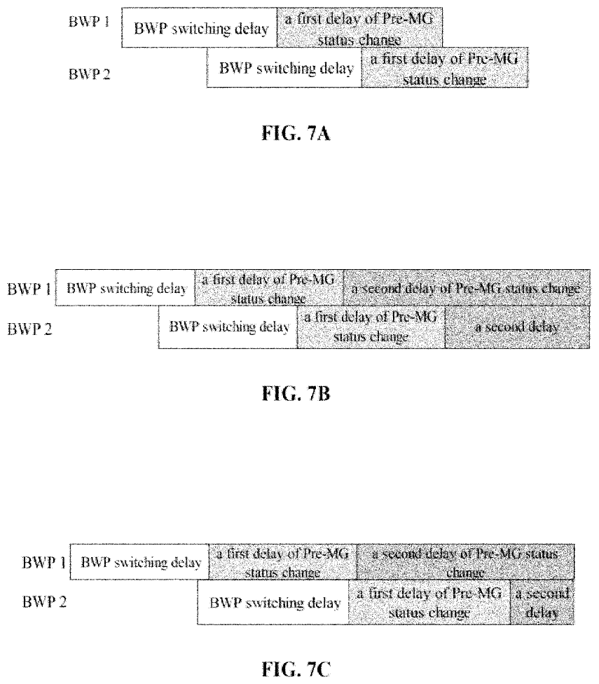

Scenarios III to VI described above with reference to FIG. 4 involve status changes (e.g., activation and/or deactivation) of multiple pre-configured MGs, durations (or delays) of the status changes were not illustrated for simplicity of FIG. 4. Next, with reference to FIGS. 6A-7C, example timelines including durations of the status changes of multiple pre-configured MGs will be illustrated.

Generally, the duration of a pre-configured MG status change indicates how long it takes to complete the status change after a particular event. Examples of the particular events may include a DCI or Timer based active BWP switching, a SCell activation and/or deactivation, or a RRC reconfiguration. In some sense, the duration may indicate a kind of delay in effectuating the pre-configured MG status change. Although the active BWP switching is more referred to in the descriptions, the descriptions are intended to be equally applied to other events. In those cases, for example, the BWP switching delay may refer to a delay caused by any of the other events.

FIG. 6A illustrates an example duration of a single pre-configured MG status change, according to embodiments disclosed herein. In the example of FIG. 6A, an active BWP switching begins at t0 in response to a switching command and completes at t1. Accordingly, the BWP switching delay (or duration) equals to t1 minus t0. The single pre-configured MG status change begins at t1 following completion of the active BWP switching, and completes at t2. Accordingly, the duration of the single pre-configured MG status change (e.g., “a first delay of Pre-MG status change” in FIG. 6A) equals to t2 minus t1.

For the single pre-configured MG status change, the first delay of the pre-configured MG status change may be of a specific value, for example, a constant value, e.g., 5 ms. For example, for the DCI or Timer based active BWP switching, the single pre-configured MG status change can be completed 5 ms after completion of the active BWP switch. For other events, for example, a SCell activation and/or deactivation, the single pre-configured MG status change can be completed 5 ms after a valid CQI report. For a RRC reconfiguration, the single pre-configured MG status change can be completed 5 ms after RRC processing delay.

In the following, the delay of the single pre-configured MG status change may be used as a baseline in the descriptions of the duration/delay of the multiple pre-configured MGs status change. Compared to the single pre-configured MG status change, the duration/delay of the multiple pre-configured MGs status change may be the same or different depending one or more capabilities of the UE.

In some embodiments, a first UE capability can be defined to indicate whether the UE supports dependent and/or independent pre-configured MG status changes for multiple BWPs. A UE supporting such independent status changes can be referred to as a type I UE, a UE supporting such dependent status changes can be referred to as a type II UE. In some embodiments, a second UE capability can be defined to indicate whether the UE supports simultaneous pre-configured MG status change on a first BWP and pre-configured MGs scheduling on a second BWPs. A UE supporting the second capability can be referred to as a type A UE, a UE without support for the second capability can be referred to as a type B UE. Both the first and the second UE capabilities are related to how the UE can handle parallel pre-configured MGs. Accordingly, in an embodiment, these two capabilities can be defined as one to reflect the above two aspects.

FIG. 6B illustrates an example duration of a multiple pre-configured MGs status change for the type I UE, according to embodiments disclosed herein. For BWP 1 and BWP 2 serving the UE, the two pre-configured MGs status change procedures can be fully overlapped with each other. This may be resulted from a same trigger event or different but simultaneous trigger events for BWP 1 and BWP 2. In the example of FIG. 6B, similar to FIG. 6A, a same event of active BWP switching triggers the two pre-configured MGs status change procedures for BWP 1 and BWP 2. The two pre-configured MGs status change procedures begins simultaneously at t1 and completes simultaneously at t2. For the type I UE, the duration of the multiple pre-configured MGs status change for the two BWPs in FIG. 6B equals to the first delay of Pre-MG status change in FIG. 6A, i.e., t2 minus t1 (e.g., 5 ms).

FIG. 6C illustrates an example duration of a multiple pre-configured MGs status change for the type II UE, according to embodiments disclosed herein. For BWP 1 and BWP 2 serving the UE, for similar reasons described above, the two pre-configured MGs status change procedures can be fully overlapped with each other. In the example of FIG. 6C, similar to FIG. 6A, a same event of active BWP switching triggers the two pre-configured MGs status change procedures for BWP 1 and BWP 2. The two pre-configured MGs status change procedures begins simultaneously at t1 and completes simultaneously at t3. For the type II UE, the duration of the multiple pre-configured MGs status change in FIG. 6C is longer than the first delay of Pre-MG status change in FIG. 6A by a second delay. For example, the second delay is for a measurement module of the UE to handle the two pre-configured MGs status change procedures dependently, including updating measurement scheduling within the measurement module.

In some embodiments, the second delay is a function of at least an incremental margin D and a number n of BWPs undergone simultaneous pre-configured MG status changes. In an example, the duration of the multiple pre-configured MGs status change in FIG. 6C is represented by X, and X=5 ms+D×(n−1). The incremental margin D can be of a pre-defined value, for example, Oms, 1 ms, 2 ms, 3 ms, or the like. In some embodiments, a second capability can be defined to indicate a per frequency range value of the incremental margin D for a duration of simultaneous pre-configured MG status changes for multiple BWPs. In an embodiment, the incremental margin D can be of a per frequency range value based on a second capability of the UE.

After discussing durations of fully overlapped multiple pre-configured MGs status change procedures, in the following, durations of partially overlapped multiple pre-configured MGs status change procedures will be described with reference to FIGS. 7A-7C.

FIG. 7A illustrates example durations of multiple pre-configured MGs status changes for the type I UE, according to embodiments disclosed herein. For BWP 1 and BWP 2 serving the UE, the two pre-configured MGs status change procedures can be overlapped with each other in part. This may be resulted from non-simultaneous trigger events for BWP 1 and BWP 2. In the example of FIG. 7A, for such non-simultaneous trigger events, the two pre-configured MGs status change procedures for BWP 1 and BWP 2 begin at different time instants, and complete at different time instants. For the type I UE, the duration of each of the two pre-configured MGs status change procedures in FIG. 7A equals to the first delay of Pre-MG status change in FIG. 6A (e.g., 5 ms).

FIGS. 7B-7C illustrates example durations of multiple pre-configured MGs status changes for the type II UE, according to embodiments disclosed herein. For BWP 1 and BWP 2 serving the UE, for similar reasons described above, the two pre-configured MGs status change procedures can be overlapped with each other in part. In the example of FIGS. 7B-7C, triggered by non-simultaneous trigger events, the two pre-configured MGs status change procedures for BWP 1 and BWP 2 begin at different time instants. For the type II UE, each of the durations of the two pre-configured MGs status change procedures in FIGS. 7B-7C is longer than the first delay in FIG. 7A by a second delay of Pre-MG status change. For example, the second delay is for a measurement module of the UE to handle the two pre-configured MGs status change procedures dependently, including updating measurement scheduling within the measurement module. Different from FIG. 7A, the two pre-configured MGs status change procedures complete simultaneously for the type II UE, since handling of one of the two pre-configured MGs status change procedures within the measurement module of the UE depends upon handling of the other. As a result, the second delay (or extension in time) represented by E1 for BWP 1 is longer than the second delay (or extension in time) represented by E2 for BWP 2, and E1=Δt+E2, where Δt is an amount of time by which a first trigger event for BWP 1 is ahead of a second trigger event for BWP 2, or is an amount of time by which the status change duration for BWP 1 is ahead of the status change duration for BWP 2.

The value of E2 can be of a pre-defined value, for example, a constant value, e.g., 0 ms, 1 ms, or the like. In some embodiments, a third UE capability is defined to indicate the extension E2 for a duration of partially overlapped pre-configured MG status changes for multiple BWPs.

In some embodiments, the value of extension E2 may be proportional to an amount of overlap between multiple pre-configured MGs status change procedures. In the example of FIGS. 7B-7C, the second delay in FIG. 7B is larger than the second delay in FIG. 7C, since the amount of overlap between the two pre-configured MGs status change procedures in FIG. 7B is greater than the amount of overlap in FIG. 7C.

There are also scenarios where multiple pre-configured MGs status change procedures are fully non-overlapped. For one of the multiple pre-configured MGs status change procedures on a BWP, the duration of the status change procedure may be equal to the first delay shown in FIG. 6A. However, there may be pre-configured MGs which are active on other BWPs during this status change procedure.

As mentioned above, a second UE capability can be defined to indicate whether the UE supports simultaneous pre-configured MG status change on a first BWP and pre-configured MGs scheduling on a second BWPs. Accordingly, if the UE is a type A UE supporting the second capability, the active pre-configured MGs on other BWPs will not be impacted by the pre-configured MGs status change procedure on the BWP during this status change procedure. For a type B UE without support for the second capability, due to the impact from the pre-configured MGs status change procedure on the BWP, the active pre-configured MGs on other BWPs will not be used during this status change procedure. The UE may update the measurement scheduling on these other BWPs each time when this status change procedure is completed.

### Example Method for the UE

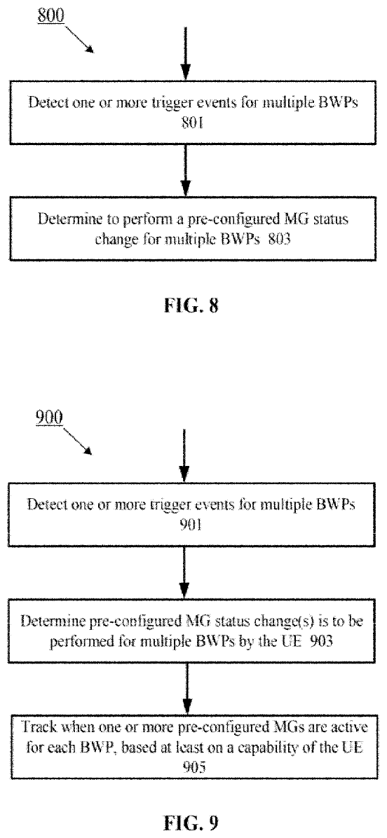

FIG. 8 illustrates an example method 800 for communication according to embodiments disclosed herein. The method 800 can be performed by a UE. In FIG. 8, the UE may correspond to any of the UEs and the wireless device of FIG. 1 and FIG. 2. The network device may correspond to any of the base stations or the network device of FIG. 1 and FIG. 2.

As shown in FIG. 8, the method 800 includes, at 801, detecting one or more trigger events for a plurality of BWPs serving the UE. The method 800 includes, at 803, in response to at least one of the one or more trigger events being detected, determining to perform a pre-configured measurement gap (MG) status change for the plurality of BWPs, wherein performing the pre-configured MG status change comprises activating or deactivating one or more pre-configured MGs for the plurality of BWPs.

In some embodiments, the method further includes receiving, from a network device, information indicating one or more pre-configured measurement gap patterns (MGPs), wherein the one or more pre-configured MGs for the plurality of BWPs are defined by the one or more pre-configured MGPs.

In some embodiments, the plurality of BWPs comprise downlink BWPs, and a number of the plurality of BWPs is any of two, three, four, or more.

In some embodiments, the one or more trigger events comprise at least one of: an active BWP switching based on a DCI, a timer or an RRC signaling; a SCell activation and/or deactivation; an addition, release and/or change of a SCell in carrier aggregation; or an addition and/or removal of one or more measurement objects.

In some embodiments, the method further includes performing the pre-configured MG status change for the plurality of BWPs further in response to a bandwidth requirement being met, wherein the bandwidth requirement comprises: a first requirement that, one or more reference signals used for measurements on a BWP after the at least one trigger event are not fully within a bandwidth of an active BWP; and/or a second requirement that, one or more reference signals used for measurements on a BWP before the at least one trigger event were not fully within the bandwidth of an active BWP.

In some embodiments, the method further includes determining, autonomously or based on a notification from a network device, if the bandwidth requirement is met for at least one of the plurality of BWPs.

In some embodiments, the method further includes activating or deactivating pre-configured MGs for the plurality of BWPs independently or in relation to each other based on a first capability of the UE, wherein the first capability indicates whether the UE supports dependent and/or independent pre-configured MG status changes for multiple BWPs.

In some embodiments, activating or deactivating the pre-configured MGs for the plurality of BWPs in relation to each other comprises at least one of: completing the pre-configured MG status change for the plurality of BWPs simultaneously; or updating pre-configured MGs scheduling on one of the plurality of BWPs every time when a pre-configured MG status change is performed for another of the plurality of BWPs.

In some embodiments, for a first BWP and a second BWP of the plurality of BWPs, performing the pre-configured MG status change comprises beginning a first pre-configured MG status change for the first BWP and a second pre-configured MG status change for the second BWP simultaneously, and completing the first and the second pre-configured MG status changes simultaneously.

In some embodiments, a duration, from completion of a respective trigger event for the first and the second BWPs to completion of the first and the second pre-configured MG status changes, is a function of at least an incremental margin D and a number n of BWPs undergone pre-configured MG status changes simultaneously.

In some embodiments, the incremental margin D is of a pre-defined value, or is of a per frequency range value based on a second capability of the UE.

In some embodiments, the at least one trigger event is an active BWP switching from the first BWP to the second BWP, and wherein the first pre-configured MG status change comprises deactivating one or more pre-configured MGs for the first BWP, and the second pre-configured MG status change comprises activating one or more pre-configured MGs for the second BWP.

In some embodiments, for a first BWP and a second BWP of the plurality of BWPs, a first duration of a first pre-configured MG status change for the first BWP is partially overlapped with a second duration of a second pre-configured MG status change for the second BWP, and the method further includes, completing the first and the second pre-configured MG status changes simultaneously.

In some embodiments, the first duration is ahead of the second duration by Δt, wherein the first duration is extended by E1 and the second duration is extended by E2 compared to a single pre-configured MG status change, and wherein E1=Δt+E2, and E2 is of a pre-defined value, or is of a value based on a third capability of the UE.

In some embodiments, for a first BWP and a second BWP of the plurality of BWPs, a first duration of a first pre-configured MG status change for the first BWP is fully non-overlapped with a second duration of a second pre-configured MG status change for the second BWP, and the method further includes: determining that one or more pre-configured MGs on the second BWP are currently active; and updating measurement scheduling on the second BWP after completion of the first pre-configured MG status change based on a fourth capability of the UE, wherein the fourth capability indicates that the UE does not support simultaneous pre-configured MG status change and pre-configured MGs scheduling on different BWPs.

Embodiments contemplated herein include an apparatus comprising means to perform one or more elements of the method 800. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 800. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a UE (such as a wireless device 202 that is a UE, as described herein).

Embodiments contemplated herein include a signal as described in or related to one or more elements of the method 800.

Embodiments contemplated herein include a computer program or computer program product comprising instructions, wherein execution of the program by a processor is to cause the processor to carry out one or more elements of the method 800. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

### Example Method for the Network Device

FIG. 9 illustrates an example method 900 for communication according to embodiments disclosed herein. The method 900 can be performed by a network device. In FIG. 9, the network device may correspond to any of the base stations or the network device of FIG. 1 and FIG. 2. The UE may correspond to any of the UEs and the wireless device of FIG. 1 and FIG. 2.

As shown in FIG. 9, the method 900 includes, at 901, detecting one or more trigger events for a plurality of BWPs serving a user equipment device (UE). The method 900 includes, at 903, determining that a pre-configured measurement gap (MG) status change is to be performed for the plurality of BWPs by the UE in response to at least one of the one or more trigger events, wherein performing the pre-configured MG status change comprises activating or deactivating one or more pre-configured MGs on the plurality of BWPs. The method 900 further includes, at 905, tracking when the one or more pre-configured MGs are active for each of the plurality of BWPs, based at least on one or more capabilities of the UE.

In some embodiments, the method further includes: transmitting, to the UE, information indicating one or more pre-configured measurement gap patterns (MGP), wherein the one or more pre-configured MGs for the plurality of BWPs are defined by the one or more pre-configured MGPs.

In some embodiments, performance of the pre-configured MG status change by the UE is further in response to a bandwidth requirement being met, wherein the bandwidth requirement comprises: a first requirement that, one or more reference signals used for measurements on a BWP after the at least one trigger event are not fully within a bandwidth of an active BWP; and/or a second requirement that, one or more reference signals used for measurements on a BWP before the at least one trigger event were not fully within the bandwidth of an active BWP.

In some embodiments, the method further includes notifying the UE if the bandwidth requirement is met for at least one of the plurality of BWPs.

In some embodiments, the one or more capabilities of the UE comprise: a first capability indicating whether the UE supports dependent and/or independent pre-configured MG status changes for multiple BWPs; a second capability indicating a per frequency range value of an incremental margin D for a duration of simultaneous pre-configured MG status changes for multiple BWPs; a third capability indicating an extension E2 for a duration of partially overlapped pre-configured MG status changes for multiple BWPs; or a fourth capability indicating whether the UE supports simultaneous pre-configured MG status change and pre-configured MGs scheduling on different BWPs.

Embodiments contemplated herein include an apparatus comprising means to perform one or more elements of the method 900. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method 900. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a base station (such as a network device 218 that is a base station, as described herein).

Embodiments contemplated herein include a signal as described in or related to one or more elements of the method 900.

Embodiments contemplated herein include a computer program or computer program product comprising instructions, wherein execution of the program by a processing element is to cause the processing element to carry out one or more elements of the method 900. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment device (UE), comprising:
one or more antennas configured to perform wireless communications;
a transceiver coupled to the one or more antennas; and
a processor coupled to the transceiver and configured to cause the UE to:
detect one or more trigger events for a plurality of BWPs serving the UE; and
in response to at least one of the one or more trigger events being detected, determine to perform a pre-configured measurement gap (MG) status change for the plurality of BWPs, wherein performing the pre-configured MG status change comprises activating or deactivating one or more pre-configured MGs for the plurality of BWPs.

2. The UE of claim 1, wherein the processor is further configured to cause the UE to:
receive, from a network device, information indicating one or more pre-configured measurement gap patterns (MGPs), wherein the one or more pre-configured MGs for the plurality of BWPs are defined by the one or more pre-configured MGPs.

3. The UE of claim 1, wherein the plurality of BWPs comprise downlink BWPs, and a number of the plurality of BWPs is any of two, three, four, or more.

4. The UE of claim 1, wherein the one or more trigger events comprise at least one of:
an active BWP switching based on a DCI, a timer or an RRC signaling;
a SCell activation and/or deactivation;
an addition, release and/or change of a SCell in carrier aggregation; or
an addition and/or removal of one or more measurement objects.

5. The UE of claim 1, wherein the processor is further configured to cause the UE to perform the pre-configured MG status change for the plurality of BWPs further in response to a bandwidth requirement being met, wherein the bandwidth requirement comprises:
a first requirement that, one or more reference signals used for measurements on a BWP after the at least one trigger event are not fully within a bandwidth of an active BWP;
and/or a second requirement that, one or more reference signals used for measurements on a BWP before the at least one trigger event were not fully within the bandwidth of an active BWP.

6. The UE of claim 5, wherein the processor is further configured to cause the UE to determine, autonomously or based on a notification from a network device, if the bandwidth requirement is met for at least one of the plurality of BWPs.

7. The UE of claim 5, wherein the processor is further configured to cause the UE to activate or deactivate pre-configured MGs for the plurality of BWPs independently or in relation to each other based on a first capability of the UE, wherein the first capability indicates whether the UE supports dependent and/or independent pre-configured MG status changes for multiple BWPs.

8. The UE of claim 7, wherein activating or deactivating the pre-configured MGs for the plurality of BWPs in relation to each other comprises at least one of:
completing the pre-configured MG status change for the plurality of BWPs simultaneously; or
updating pre-configured MGs scheduling on one of the plurality of BWPs every time when a pre-configured MG status change is performed for another of the plurality of BWPs.

9. The UE of claim 5, wherein, for a first BWP and a second BWP of the plurality of BWPs, performing the pre-configured MG status change comprises beginning a first pre-configured MG status change for the first BWP and a second pre-configured MG status change for the second BWP simultaneously, and completing the first and the second pre-configured MG status changes simultaneously.

10. The UE of claim 9, wherein a duration, from completion of a respective trigger event for the first and the second BWPs to completion of the first and the second pre-configured MG status changes, is a function of at least an incremental margin D and a number n of BWPs undergone pre-configured MG status changes simultaneously.

11. The UE of claim 10, wherein the incremental margin D is of a pre-defined value, or is of a per frequency range value based on a second capability of the UE.

12. The UE of claim 9, wherein the at least one trigger event is an active BWP switching from the first BWP to the second BWP, and wherein the first pre-configured MG status change comprises deactivating one or more pre-configured MGs for the first BWP, and the second pre-configured MG status change comprises activating one or more pre-configured MGs for the second BWP.

13. The UE of claim 5, wherein, for a first BWP and a second BWP of the plurality of BWPs, a first duration of a first pre-configured MG status change for the first BWP is partially overlapped with a second duration of a second pre-configured MG status change for the second BWP, and the processor is further configured to cause the UE to:
complete the first and the second pre-configured MG status changes simultaneously.

14. The UE of claim 13, wherein the first duration is ahead of the second duration by Δt, wherein the first duration is extended by E1 and the second duration is extended by E2 compared to a single pre-configured MG status change, and wherein E1=Δt+E2, and E2 is of a pre-defined value, or is of a value based on a third capability of the UE.

15. The UE of claim 5, wherein, for a first BWP and a second BWP of the plurality of BWPs, a first duration of a first pre-configured MG status change for the first BWP is fully non-overlapped with a second duration of a second pre-configured MG status change for the second BWP, and the processor is further configured to cause the UE to:
determine that one or more pre-configured MGs on the second BWP are currently active; and
update measurement scheduling on the second BWP after completion of the first pre-configured MG status change based on a fourth capability of the UE, wherein the fourth capability indicates that the UE does not support simultaneous pre-configured MG status change and pre-configured MGs scheduling on different BWPs.

16. A network device, comprising:
one or more antennas configured to perform wireless communications;
a transceiver coupled to the one or more antennas; and
a processor coupled to the transceiver and configured to cause the network device to:
detect one or more trigger events for a plurality of BWPs serving a user equipment device (UE);
determine that a pre-configured measurement gap (MG) status change is to be performed for the plurality of BWPs by the UE in response to at least one of the one or more trigger events, wherein performing the pre-configured MG status change comprises activating or deactivating one or more pre-configured MGs on the plurality of BWPs; and
track when the one or more pre-configured MGs are active for each of the plurality of BWPs, based at least on one or more capabilities of the UE.

17. The network device of claim 16, wherein the processor is further configured to cause the network device to:
transmit, to the UE, information indicating one or more pre-configured measurement gap patterns (MGP), wherein the one or more pre-configured MGs for the plurality of BWPs are defined by the one or more pre-configured MGPs.

18. The network device of claim 16, wherein performance of the pre-configured MG status change by the UE is further in response to a bandwidth requirement being met, wherein the bandwidth requirement comprises:
a first requirement that, one or more reference signals used for measurements on a BWP after the at least one trigger event are not fully within a bandwidth of an active BWP; and/or
a second requirement that, one or more reference signals used for measurements on a BWP before the at least one trigger event were not fully within the bandwidth of an active BWP.

19. The UE of claim 18, wherein the processor is further configured to cause the network device to notify the UE if the bandwidth requirement is met for at least one of the plurality of BWPs.

20. The network device of claim 16, wherein the one or more capabilities of the UE comprise:
a first capability indicating whether the UE supports dependent and/or independent pre-configured MG status changes for multiple BWPs;
a second capability indicating a per frequency range value of an incremental margin D for a duration of simultaneous pre-configured MG status changes for multiple BWPs;
a third capability indicating an extension E2 for a duration of partially overlapped pre-configured MG status changes for multiple BWPs; or
a fourth capability indicating whether the UE supports simultaneous pre-configured MG status change and pre-configured MGs scheduling on different BWPs.

21-23. (canceled)
